(19) United States
(12) Patent Application Publication
(10) Pub. No.: US 2010/0153849 A1
(43) Pub. Date: Jun. 17, 2010

(54) DYNAMIC IMAGE SLIDESHOW DISPLAY SYSTEMS, METHODS, AND COMPUTER PROGRAM PRODUCTS

(76) Inventor: Joshua S. West, Aurora, CO (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 12/637,740

(22) Filed: Dec. 14, 2009

Related U.S. Application Data
(60) Provisional application No. 61/121,984, filed on Dec. 12, 2008.

(51) Int. Cl. G06F 3/01

(52) U.S. Cl. 715/730

(57) ABSTRACT

In one example, a slideshow is presented, wherein the images to be viewed are presented in a first slideshow area, and a video or animation is presented in a second slideshow area that at least partially surrounds the first slideshow area. Thus, as user images are presented in the first area, the video or animation in the second area may be used to entertain the viewer or to give context to the slideshow.

### FIELD

The present disclosure relates to methods, systems, and computer program products for dynamically displaying user images as a slideshow on a user interface.

### BACKGROUND

The statements in this section merely provide background information related to the present disclosure and may not constitute prior art.

Viewing a plethora of individual images displayed by, for example, a webpage, can be tiresome for users. When the data to be displayed is greater than the amount of data that can be displayed within a user's screen, the user must select a vertical side scroll bar or a horizontal side scroll bar to scroll through the data either horizontally or vertically.

However, the industry has provided slideshow features that permit a user to select one or more images to be viewed in succession, with a user-defined delay between slides. Slideshows remove the requirement that a user manually select each image for viewing. There is room in the industry for improvements, particularly with regard to the way such slideshows are presented to the user.

### SUMMARY

In one example, a slideshow is presented, wherein the images to be viewed are presented in a first slideshow area, and a video or animation is presented in a second slideshow area that at least partially surrounds the first slideshow area. Thus, as user images are presented in the first area, the video or animation in the second area may be used to entertain the viewer or to give context to the slideshow.

Thus, in a first exemplary embodiment, a second area animation may be, e.g., an animated fireworks show, which gives context to a user album or selected user images relating to the fourth of July. In other exemplary embodiments, the second area may be a video, e.g., of a holiday that gives context to holiday related images. In other exemplary embodiments, the second area may be a video or animation of an individual, celebrity, model, etc. virtually presenting the user images in the first area, e.g., as if the first area were a poster or placard of the image.

Also, in exemplary embodiments, animations or video relating to the second area may be presented at least partially over or may move at least partially over the first area, e.g., where portions of an animated fireworks explosion trail over a portion of the image shown in the first area. Also, the first area need not be stationary relative to the animation or video of the second area, e.g., in the exemplary case of an individual in the second area virtually presenting the first area as a poster or placard.

Further areas of applicability will become apparent from the description provided herein. It should be understood that the description and specific examples are intended for purposes of illustration only and are not intended to limit the scope of the present disclosure.

### BRIEF DESCRIPTION OF THE SEVERAL VIEWS OF THE DRAWINGS

The drawings described herein are for illustration purposes only and are not intended to limit the scope of the present disclosure in any way. It should be understood that throughout the drawings, corresponding reference numerals indicate like or corresponding parts and features.

FIG. 1 is a block diagram illustrating a computing system that includes a dynamic image slideshow display system in accordance with an exemplary embodiment of the present disclosure;

FIG. 2 is a block diagram illustrating a dynamic slideshow interface having distinct content areas in accordance with an exemplary embodiment of the present disclosure;

FIG. 3 is a block diagram illustrating additional video or animation portions visible over the first and second areas in accordance with an exemplary embodiment of the present disclosure.

FIG. 4 is a block diagram illustrating a dynamically movable first area in accordance with an exemplary embodiment of the present disclosure.

### DETAILED DESCRIPTION

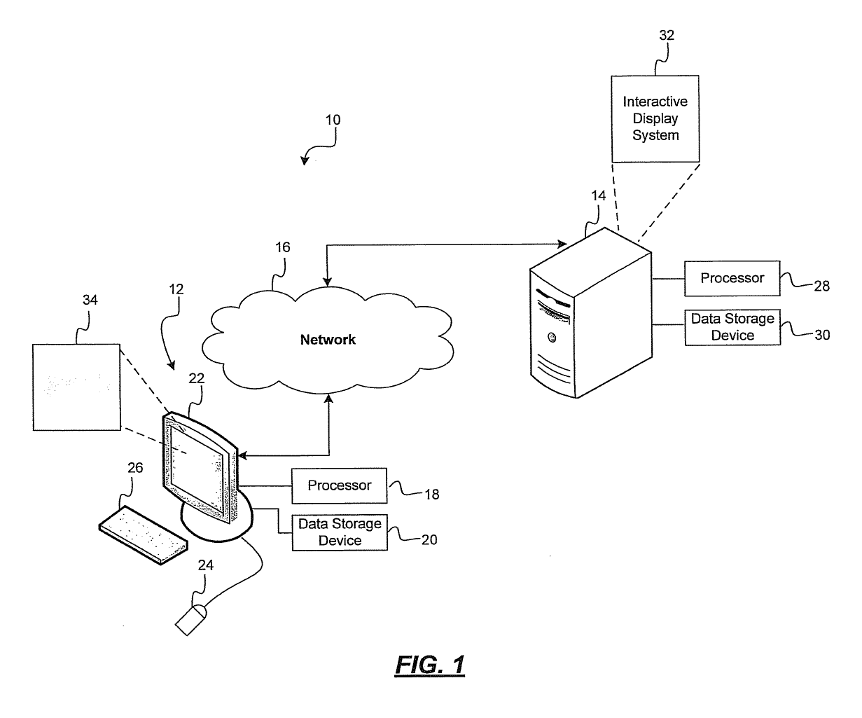

Turning now to the drawings in greater detail, it will be seen that in FIG. 1 an exemplary computing system 10 includes an interactive display system of the present disclosure. The exemplary computing system 10 is shown to include a computer 12 that communicates with a server 14 via a network 16. The computer 12 includes a processor 18 and one or more data storage devices 20. The one or more data storage devices 20 can be at least one of random access memory (RAM), read only memory (ROM), a cache, a stack, or the like which may temporarily store electronic data of the computer 12. The processor 18 can be any custom made or commercially available processor, a central processing unit (CPU), an auxiliary processor among several processors associated with the computer, a semiconductor based microprocessor (in the form of a microchip or chip set), a macroprocessor, or generally any device for executing software instructions.

As can be appreciated, the computer 12 can be any computing device that includes a processor 18 and a data storage device 20, including, but not limited to, a desktop computer, a laptop, a workstation, a cell phone, and a personal handheld device. The computer 12 is shown to be associated with a display 22 and one or more input devices 24, 26 that can be used by a user to communicate with the computer 12. As can be appreciated, such input devices 24, 26 can include, but are not limited to, a mouse, a keyboard, and a touchpad.

The server 14 similarly includes one or more processors 28 and one or more data storage devices 30. At least one of the data storage devices 30 of the server 14 stores one or more instructions contained in the dynamic slideshow display system 32 of the present disclosure. The interactive display system 32 can be accessed by a user of the computer 12 through the network 16 by way of, for example, an Internet Protocol (IP) address. When accessed by a user of the computer 12, the dynamic slideshow display system 32 generates an dynamic slideshow user interface 34 that is displayed by the display 22 of the computer 12.

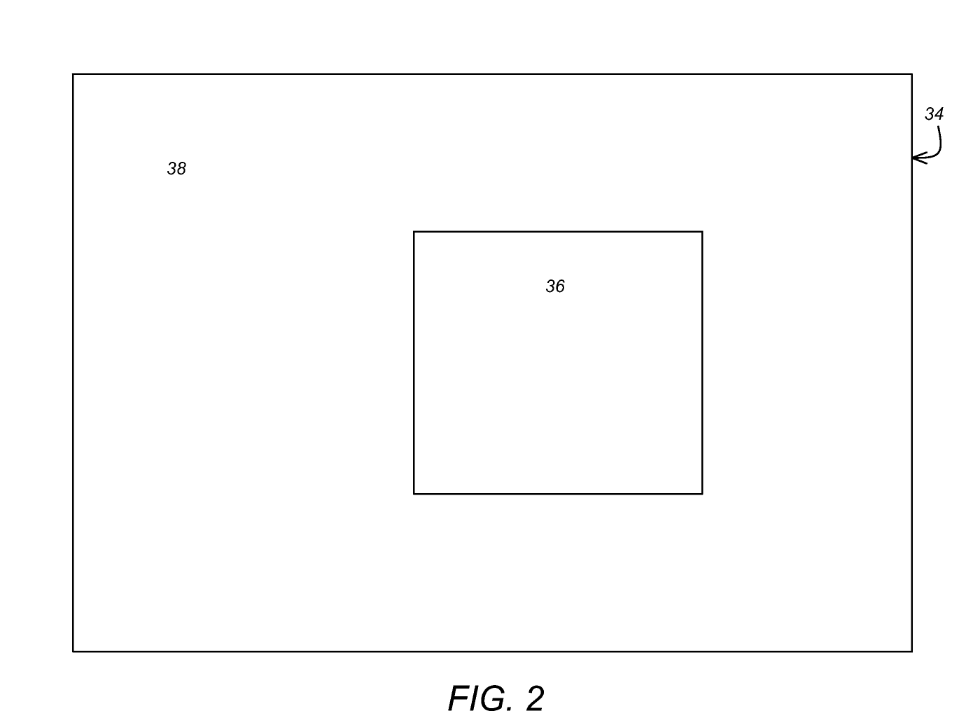

Generally speaking and with reference to FIG. 2, the dynamic slideshow user interface 34 presents a dynamic slideshow, wherein the images to be viewed are presented in a first slideshow area 36, and a video or animation is presented in a second slideshow area 38 that at least partially surrounds the first slideshow area 36. Thus, as user images are presented in the first area 36, the video or animation in the second area 38 may be used to entertain the viewer or to give context to the slideshow.

Thus, in a first exemplary embodiment, a second area animation may be, e.g., an animated fireworks show, which gives context to a user album or selected user images relating to the fourth of July, a billboard, etc. In other exemplary embodiments, the second area may be a video, e.g., of a holiday that gives context to holiday related images. In other exemplary embodiments, the second area may be a video or animation of an individual, celebrity, model, etc. virtually presenting the user images in the first area, e.g., as if the first area were a poster or placard of the image.

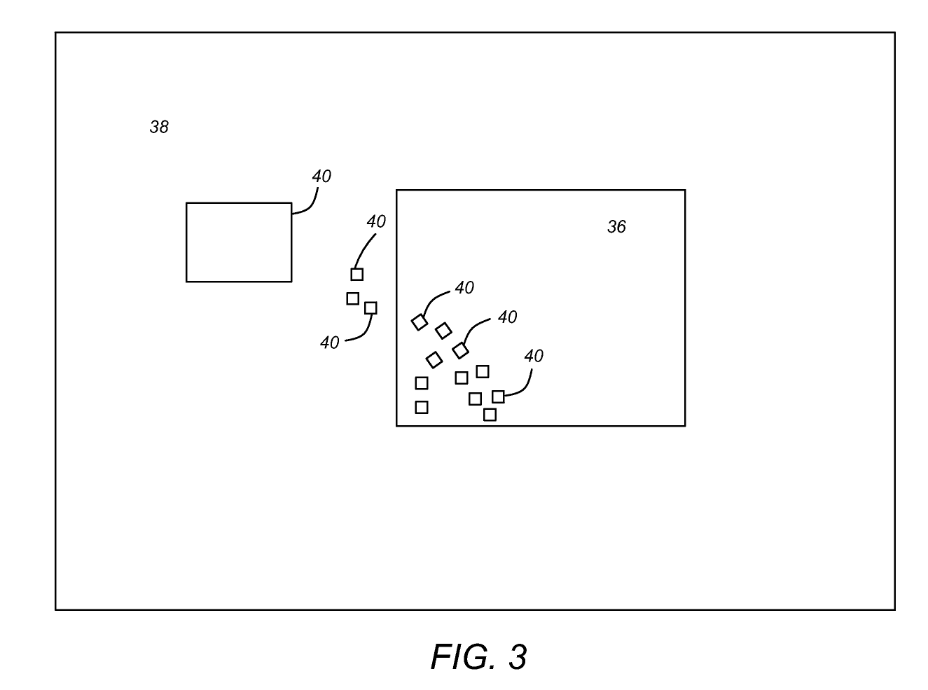

Also, in exemplary embodiments, animations or video relating to the second area may be presented at least partially over or may move at least partially over the first area, e.g., where portions (see animated portions 40 in FIG. 3) of an animated fireworks explosion trail over a portion of the image shown in the first area 36. Such portions may be additional stationary or moving frames visible over the slideshow, which may be, for example, a frame that is at least partially visible over the animation or video of the second area 38. Also, in exemplary embodiments, the movement or placement of portions 40 may relate to the animation or video in the second area, e.g., as naturally flowing from an explosion trail of fireworks or as being hands associated with arms of a presenting individual. Additionally, animations or video may be visible over both frames, e.g., where the portions 40 are part of additional animation overlying the second area as well.

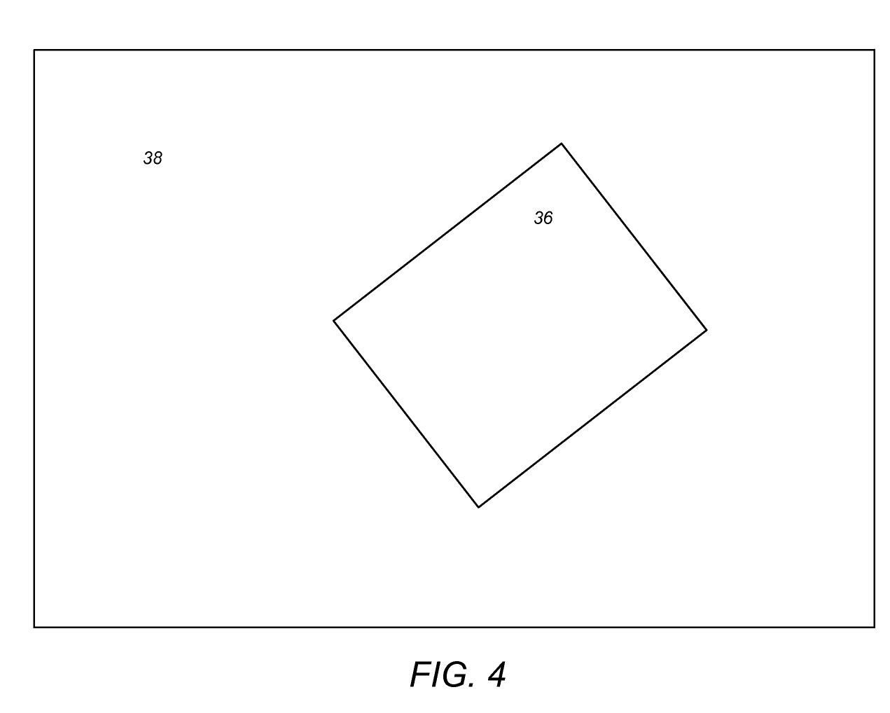

Also, the first area 36 need not be stationary relative to the animation or video of the second area 38, e.g., in the exemplary case of an individual in the second area virtually presenting the first area as a poster or placard (see the changed orientation of the first area 36 in FIG. 4 relative to FIG. 3). Indeed, in exemplary embodiments any change in orientation may be made, including rotation (e.g., turning of an image placard by an individual), enlargement (e.g., an individual moving an image placard closer to the viewer), etc. In such cases, the displayed image may be dynamically scaled, rotated, etc. as needed to maintain the proper frame of reference relative to the first area.

In exemplary embodiments, the presented slideshow is flash-based. Images may also be dynamically pulled from a storage location (e.g., images or albums of users of online providers). Also, video or animation may be pre-set, or may be loaded from user files (e.g., user recorded video).

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

Computer program code for carrying out operations of the present invention may be written in any combination of one or more programming languages, including an object oriented programming language such as XML, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

1. An dynamic slideshow user interface, comprising:
a dynamic display window, including a first image slideshow area, configured to illustrate successions of user images loaded from a storage device and
a second area configured to display video or animation, wherein the second slideshow area at least partially surrounds the first slideshow area.

2. A dynamic slideshow user interface in accordance with claim 1, wherein the second area comprises an animated fireworks show.

3. A dynamic slideshow user interface in accordance with claim 1, wherein the second area comprises an animated individual configured as holding the first image slideshow area.

4. A dynamic slideshow user interface in accordance with claim 3, wherein the animated individual is configured to hold and move the first image slideshow area as if it were a placard or post card.

5. A dynamic slideshow user interface in accordance with claim 1, wherein at least a portion of the second area is configured to overly or move at least partially over the first area.

6. A dynamic slideshow user interface in accordance with claim 5, wherein the second area comprises an animated fireworks show having portions configured to move at least partially over the first area.

7. A dynamic slideshow user interface in accordance with claim 1, wherein the first area is configured to move relative to the second area.

8. A dynamic slideshow user interface in accordance with claim 7, wherein the first area is configured to rotate relative to the second area.

9. A dynamic slideshow user interface in accordance with claim 7, wherein the first area is configured to increase or decrease in size relative to the second area.
